(19) United States
(12) Patent Application Publication
(10) Pub. No.: US 2009/0179360 A1
(43) Pub. Date: Jul. 16, 2009

(54) Hydraulic Ride Bushing Having Improved End of Bushing Travel Damping

(75) Inventors: Shawn G. Quinn, Grand Blanc, MI (US); Elmer V. Childers, Lapeer, MI (US); Gregory J. Fadler, Commerce Township, MI (US)

Correspondence Address: GENERAL MOTORS CORPORATION;LEGAL STAFF, MAIL CODE 482-C23-B21, P O BOX 300, DETROIT, MI, 48265-3000, US

(73) Assignee: GM GLOBAL TECHNOLOGY OPERATIONS, INC., DETROIT, MI (US)

(21) Appl. No.: 12/014,819

(22) Filed: Jan. 16, 2008

(51) Int. Cl. F16F 5/00

(52) U.S. Cl. 267/140.11

(57) ABSTRACT

An hydraulic ride bushing having improved damping at the end of its travel. In various aspects thereof to provide the improved damping at the end of bushing travel: the external snubbers are composed entirely of polyurethane; the abutment portions of the external snubbers are composed of polyurethane; the external snubbers are provided with a plurality of convolutes; the external snubbers are composed of a dual durometer composition; an internal snubber is added between an hydraulic damper and an outer cylindrical shell; an hydraulic lock is provided at the hydraulic damper; and an external hydraulic damper is provided which is disposed externally with respect to the outer cylindrical shell.

### TECHNICAL FIELD

The present invention relates to ride bushings used, for example, in motor vehicles, and more particularly to a ride bushing having improved end of bushing travel damping.

### BACKGROUND OF THE INVENTION

As depicted at FIG. 1, hydraulic ride bushings 10 are utilized, typically, in motor vehicles between, for example, a cradle 12 and a control arm 14. In this respect, the bushing provides impact shock damping of the control arm with respect to the cradle. In operation, unless the hydraulic ride bushing has sufficient internal travel over which its damping components can operate, a hard impact can be perceived by passengers of the motor vehicle.

As can be seen at FIGS. 2 and 2A, a typical prior art hydraulic ride bushing 10 includes an outer cylindrical shell 20, an hydraulic damper 22 including an internal hydraulic damping mechanism and a resilient material, such as a rubber, a sleeve 24 having a central passage 24a through which passes a fastener (such as for example the bolt 16 in FIG. 1), first and second external snubbers 26a, 26b, and first and second external end caps 28a, 28b. The hydraulic damper 22 has a recess 22r at each end thereof, and a pair of radially opposed bosses 22a, 22b are located at each recess.

In the environment of operation depicted at FIG. 1, the cradle 12 has a clevis 12a and the control arm has a barrel 14a into which the hydraulic ride bushing 10 is seated. The hydraulic ride bushing 10 and the barrel 14a are received by the clevis 12a, and the bolt 16 passes therethrough, being secured by a nut. Forces applied to the control arm 14 with respect to the cradle 12 are along a radial force axis F (that is, radial in relation to the central axis A_{X} of the central passage 14a through which the bolt passes).

As shown as a schematic cross-section at FIG. 2B, a conventional prior art hydraulic damper 22 has an internal hydraulic damping mechanism 22d, which is schematically represented by a first hydraulic fluid reservoir 22e connected to a first expansion bladder 22f, and an oppositely disposed second hydraulic fluid reservoir 22g connected to a second expansion bladder 22h. In operation, when the hydraulic damper 22 is subjected to an applied load force, hydraulic fluid flows from the respectively compressed hydraulic fluid reservoir to its connected expansion bladder either freely or by uncontrolled metering.

In operation of the hydraulic ride bushing 10 in the exemplar environment of FIG. 1, as an impact shock is applied by the control arm 14 to the cradle 12, the hydraulic ride bushing responds by the hydraulic fluid of the hydraulic fluid mechanism within the hydraulic damper being internally redistributed so as to cushion the compressive load of the force of the impact. When the end of bushing travel approaches (by “bushing travel” is meant travel of the central axis A_{X} radially with respect to the outer cylindrical shell 20), the external snubbers 26a, 26b each have, respectively, abutment portions 26a′, 26a″, 26b′, 26b″ that abut one or the other of the opposed bosses 22a, or 22b depending on the direction of the radial movement, and thereupon compress thereagainst, providing a high load stop in order to prevent the hydraulic damper from possible rupture. The external snubbers used in the prior art are made of GF33RN 30% glass filled nylon, which has a very high modulus of elasticity; and, the bushing travel is typically in the range of about 13 to 15 mm.

What remains needed in the art is a hydraulic ride bushing which has improved damping at the ends of its travel, particularly in applications wherein less than 13 to 15 mm of bushing travel is permitted.

### SUMMARY OF THE INVENTION

The present invention is an hydraulic ride bushing having improved damping at the end of its travel, including for bushing travel limitations under 13 to 15 mm.

According to a first aspect of the present invention, generally conventionally shaped external snubbers are now composed entirely of a polyurethane material, as for example FPU 1376-13 polyurethane, which has a very low modulus of elasticity. The polyurethane external snubbers exhibit a smooth load rate increase at the ends of travel of the hydraulic damper to thereby provide a smooth end of travel feel due to the additional damping at the end of bushing travel.

According to a second aspect of the present invention, the abutment portions of the external snubbers are each composed of polyurethane, wherein the polyurethane abutment portions exhibit a smooth load rate increase at the ends of travel of the hydraulic damper to thereby provide a smooth end of travel feel due to the additional damping at the end of bushing travel.

According to a third aspect of the present invention, the abutment interface between the abutment portion of external snubbers and the bosses of the hydraulic damper is provided with a plurality of convolutes (i.e., a plurality of nibs, folds or the like), wherein in one version convolutes are provided on the abutment portions of the external snubbers, and in a second version a plurality of convolutes are provided on the bosses of the hydraulic damper, wherein because the abutment is first occurs at the convolutes, provided is a smooth load rate increase at the ends of travel of the hydraulic damper which thereby provides a smooth end of travel feel due to the additional damping at the end of bushing travel.

According to a fourth aspect of the present invention, the external snubbers are composed of a dual durometer composition (i.e., two different elastic modulus materials), a first, softer elastic modulus material and a second, harder elastic modulus material, ether throughout the structure, or at the abutment portions thereof. The softer and harder materials combine to provide a smooth load rate increase at the end of travel of the hydraulic damper and thereby provide a smooth end of travel feel due to the additional damping at the end of bushing travel.

According to a fifth aspect of the present invention an internal snubber is added between the hydraulic damper and the outer cylindrical shell of the hydraulic ride bushing. The elastic modulus of the internal snubber is selected to provide a smooth load rate increase at the ends of travel of the hydraulic damper to thereby provide a smooth damping during the end of bushing travel; and, where external snubbers are also present, the elastic modulus of the internal and external snubbers are selected in combination to provide a smooth load rate increase at the ends of travel of the hydraulic damper to thereby provide a smooth end of travel feel due to the additional damping at the end of bushing travel.

According to a sixth aspect of the present invention, an hydraulic lock is provided which interfaces with the hydraulic fluid of the hydraulic damping mechanism of the hydraulic damper, wherein the hydraulic lock is internal to the hydraulic ride bushing, and wherein the hydraulic lock is predetermined so as to provide a smooth load rate increase at the ends of travel of the hydraulic damper to thereby provide a smooth end of travel feel due to the additional damping at the end of bushing travel.

According to a seventh aspect of the present invention, an external hydraulic damper is provided which is disposed externally with respect to the outer cylindrical shell of the hydraulic ride bushing, for example being operatively similar to a conventional internally disposed hydraulic damper, or having the hydraulic lock of the sixth aspect of the present invention. The external damper is selected in combination with the hydraulic damper within the hydraulic ride bushing so as to provide a smooth load rate increase at the ends of travel of the hydraulic damper to thereby provide a smooth end of travel feel due to the additional damping at the end of bushing travel.

Accordingly, it is an object of the present invention to provide an hydraulic ride bushing having improved damping at the end of its travel, including for bushing travel limitations under 13 to 15 mm.

This and additional objects, features and advantages of the present invention will become clearer from the following specification of a preferred embodiment.

### BRIEF DESCRIPTION OF THE DRAWINGS

The preferred embodiment is be read in conjunction with the accompanying drawings, wherein at FIGS. 4A, 4B, 4C, 6, 7A, 7B, 8, 8A, 10, and 11A, the end views are schematic, and the rendering of the external snubbers is schematically hexagonal for simplicity.

FIG. 1 is an isometric view of a cradle and control arm of a motor vehicle suspension, wherein an hydraulic ride bushing is operably interfaced therebetween.

FIG. 2 is an isometric view of a prior art hydraulic ride bushing.

FIG. 2A is a perspective, exploded view of the internal components of the prior art hydraulic ride bushing of FIG. 2.

FIG. 2B is a cross-sectional schematic view of the prior art hydraulic damper of the hydraulic ride bushing of FIGS. 2 and 2A.

FIG. 3 is a perspective view of a pair of external snubbers according to a first aspect of the present invention.

FIG. 4A is an end view of an hydraulic ride bushing including the external snubbers of FIG. 3.

FIG. 4B is an end view of the hydraulic ride bushing of FIG. 4A, showing end of travel in response to a “downward” radial force being applied thereto.

FIG. 4C is an end view of the hydraulic ride bushing of FIG. 4A, showing end of travel in response to an “upward” radial force being applied thereto.

FIG. 5 is a graph of displacement versus load, wherein a first plot is for conventional prior art external snubbers, and a second plot is for external snubbers according to the first aspect of the present invention.

FIG. 6 is an end view of an hydraulic ride bushing utilizing the external snubbers according to a second aspect of the present invention.

FIG. 7A is an end view of an hydraulic ride bushing according to a second version of a third aspect of the present invention.

FIG. 7B is a perspective view of a pair of external snubbers according to the first version of the third aspect of the present invention.

FIG. 7C is an end view of an hydraulic ride bushing according to a second version of the third aspect of the present invention.

FIG. 8 is an end view of an hydraulic ride bushing including external snubbers having dual durometer according to a fourth aspect of the present invention.

FIG. 8A is an end view of an hydraulic ride bushing including external snubbers having dual durometer according to a variation of the fourth aspect of the present invention.

FIG. 9 is a side view of an hydraulic ride bushing according to a fifth aspect of the present invention.

FIG. 9A is a cross-sectional view, seen along line 9A-9A of FIG. 9, of an internal snubber of the fifth aspect of the present invention.

FIG. 10 is an end view of an hydraulic ride bushing according to a sixth aspect of the present invention, wherein an internal hydraulic lock apparatus is included.

FIG. 10A is a cross-sectional schematic view of the hydraulic damper of the hydraulic ride bushing of FIG. 10.

FIG. 10B is a cross-sectional schematic view of the hydraulic damper as in FIG. 10A, shown operationally providing damping of an applied load.

FIG. 11 is a side view of an hydraulic ride bushing according to a seventh aspect of the present invention, wherein an external hydraulic damper has an optional internal hydraulic lock apparatus.

FIG. 11A is an end view of an hydraulic ride bushing according to the seventh aspect of the present invention.

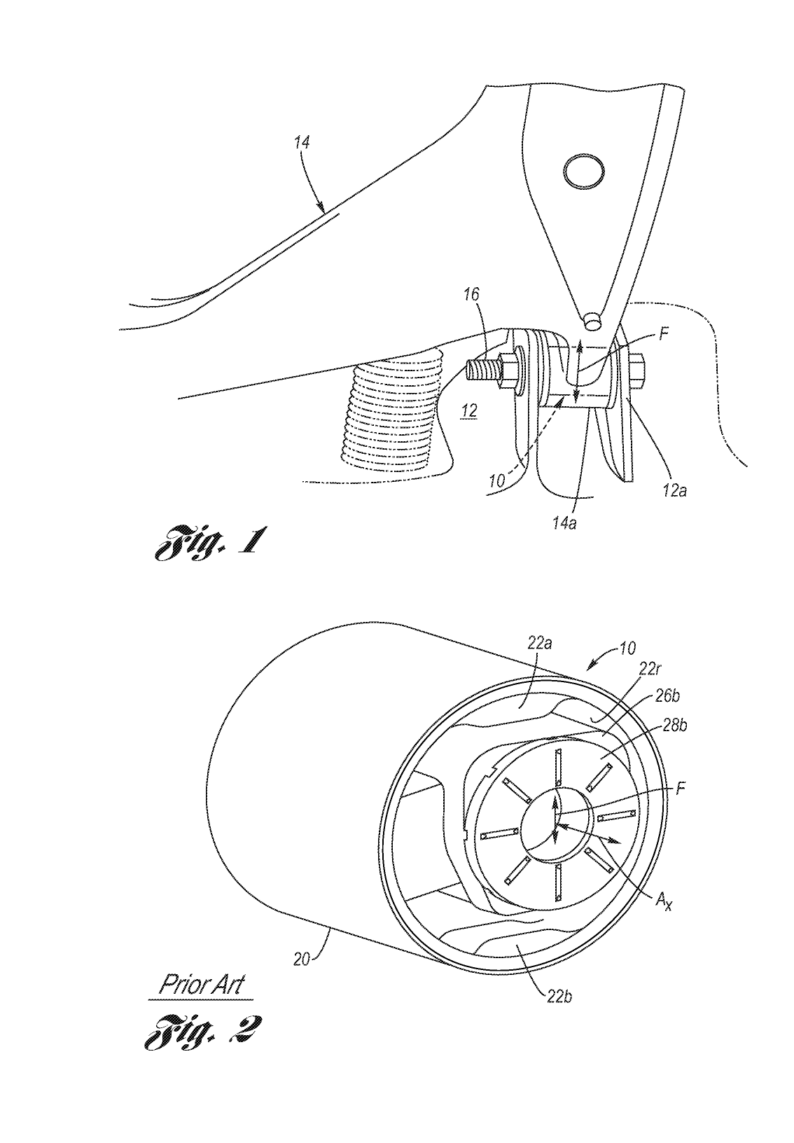

### DESCRIPTION OF THE PREFERRED EMBODIMENT

Referring now to the Drawing, FIGS. 3 through 11A depict various aspects of an hydraulic ride bushing having improved end of bushing travel damping according to the present invention.

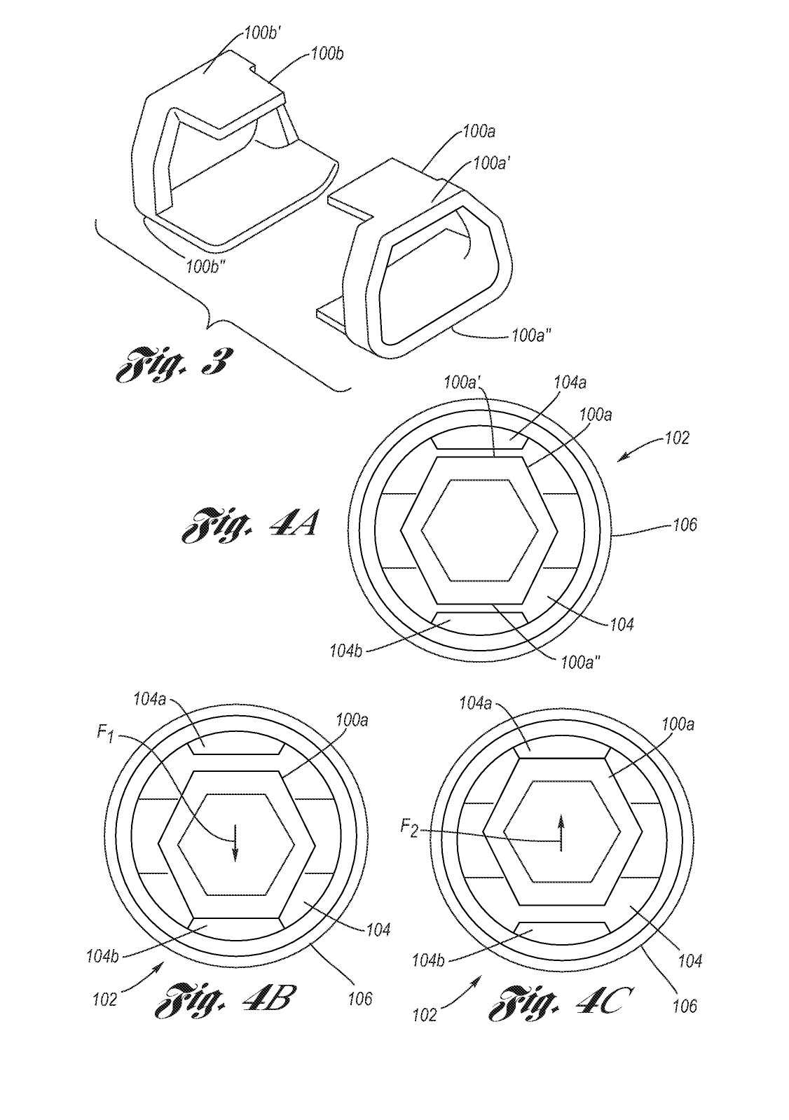

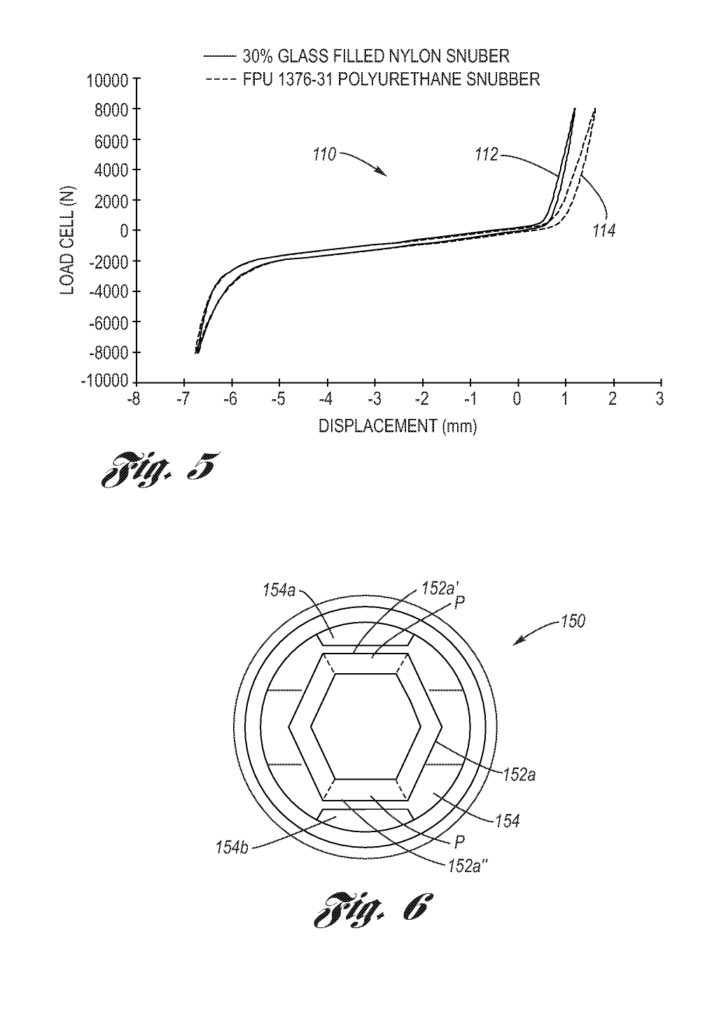

Turning attention firstly to FIGS. 3 through 5, depicted is a first aspect of the present invention, wherein improved first and second external snubbers 100a, 100b are provided. The first and second external snubbers 100a, 100b include respective abutment portions 100a′, 100a″, 100b′, 100b″ which are intended to face respective bosses of an hydraulic damper 102 (see FIG. 4A). The first and second external snubbers 100a, 100b are configured like that of the above described conventional external snubbers 26a, 26b, but now the material composition has been changed from the very high modulus of elasticity material of 30% glass filled nylon to a polyurethane material, as for example, FPU 1376-31 polyurethane, which has a very low modulus of elasticity. The first and second external snubbers 100a, 100b exhibit a smooth load rate increase at the ends of bushing travel so as to thereby provide a smooth damping during the end of bushing travel.

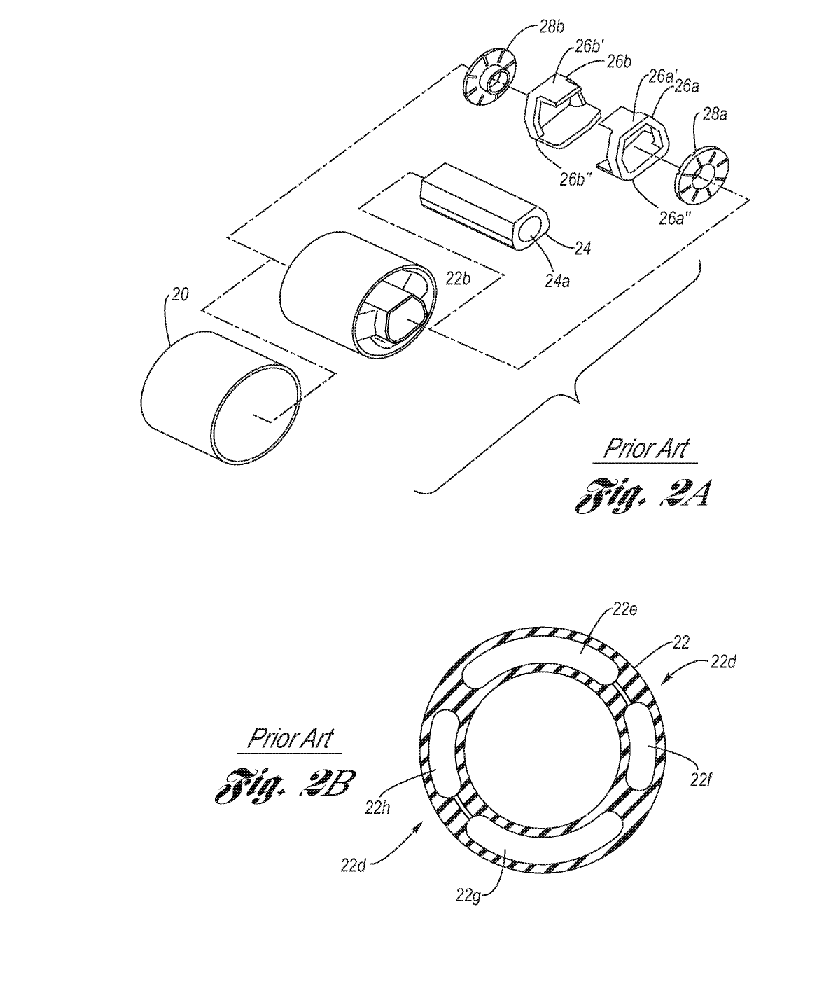

As shown at FIG. 4A, the hydraulic ride bushing 102 has the improved first and second external snubbers composed (entirely) of polyurethane (the end cap and sleeve being removed for clarity, and wherein only the first external snubber 100a is visible), wherein the hydraulic ride bushing may be otherwise conventional as described with respect to FIGS. 2 and 2A, i.e., having an outer cylindrical shell 106, hydraulic damper 104, end caps (not visible for clarity) and sleeve (not visible for clarity).

As shown at FIGS. 4B and 4C, in the event an applied load is delivered to the hydraulic ride bushing 102, providing a “downward” applied load radial force F₁ or an “upward” applied load radial force F₂, the hydraulic damper 104 responds by providing damping in opposition thereto. When the limit of bushing travel is approached, the first and second external snubbers 100a, 100b abut the appropriate boss 104a or 104b (located at each end) of the hydraulic damper 104, whereupon the load is damped by a smooth rate increase without an abrupt impact.

The nature of the foregoing operation is exemplified by FIG. 5, which is a graph 110 of displacement versus load in a load cell. Plot 112 is for the conventional external snubber material composed of GF33RN 30% glass filled nylon, and plot 114 is for the improved external snubber material according to the present invention composed of FPU 1376-31 polyurethane, both being utilized in the identically configured hydraulic ride bushing. The larger area in the Plot 114 loop is indicative of increased damping as compared to plot 112. Plot 114 also has an increased bushing travel as compared to plot 112, and further the right hand portion of Plot 114 has a lower slope with less of a knee than plot 112. Thus, plot 114 shows a much smoother rate build which provides for a smooth end of travel feel due to the additional damping at the end of bushing travel.

Table I compares several of the properties of these snubber materials, namely GF33RN 30% glass filled nylon FPU 1376-31 polyurethane, which underlies the reason for the benefits provided by the polyurethane snubbers over the 30% glass filled snubbers, and an operational example is presented at Example I.

TABLE I

| | Polyurethane | 30% Glass Filled Nylon |
|---|---|---|
| Property | FPU 1376-31 | GF33RN |
| Specific Gravity | 1.29 | 1.4 |
| Tensile Strength | 35 Mpa | 100 Mpa |
| Tensile Elongation | 30% | 4% |
| Flexural Modulus | 1,400 Mpa | 5,200 Mpa |
| Notched Izod | 200 J/m | 59 J/m |
| HDT @ 0.45 Mpa | 90 C. | 254 C. |
| Mold Shrinkage | 0.1 to 0.3% | 0.4% |

### Example I

By way of example in a motor vehicle application it was desired to alter the bushing travel of the hydraulic ride bushing from 15 mm to 7 mm. In order to avoid a harsh impact and reduced durability (as would occur if the conventional external snubber material (i.e., GF33RN 30% glass filled nylon) was retained), the external snubbers were instead made entirely of FPU 1376-31 polyurethane. It was determined that the FPU 1376-31 polyurethane external snubbers provided a passenger feel over the shortened bushing travel of 7 mm which felt similar to that provided by GF33RN 30% glass filled nylon conventional external snubbers over the conventional bushing travel of 15 mm, and still provided the desired durability. When the travel was reduced from 15 mm to 7 mm, the GF33RN 30% glass filled nylon external snubbers resulted in degradation of: impact hardness performance (−1.5 General Motors Uniform Test Standard (GMUTS)), ride isolation (−1.0 GMUTS), and overall ride integration feel (−1.0 GMUTS); however, the FPU 1376-31 polyurethane external snubbers provided improved: vehicle impact envelopment, impact hardness performance, ride isolation, and overall ride integration feel; and provided desired durability and desired smooth road shake.

By way of further exemplification, external snubbers composed of Santoprene™ were also tested. These external snubbers exhibited very low modulus of elasticity, including a smooth load rate increase at the ends of bushing travel so as to thereby provide a smooth damping during the end of bushing travel, similar to that of the FPU 1376-31 polyurethane external snubbers; however, the Santoprene™ external snubbers had unacceptable durability. Accordingly, it is seen that polyurethane is preferred in that it provides not only the desired very low modulus of elasticity resulting in a smooth load rate increase at the ends of bushing travel so as to thereby provide a smooth damping during the end of bushing travel, but the desired durability, as well.

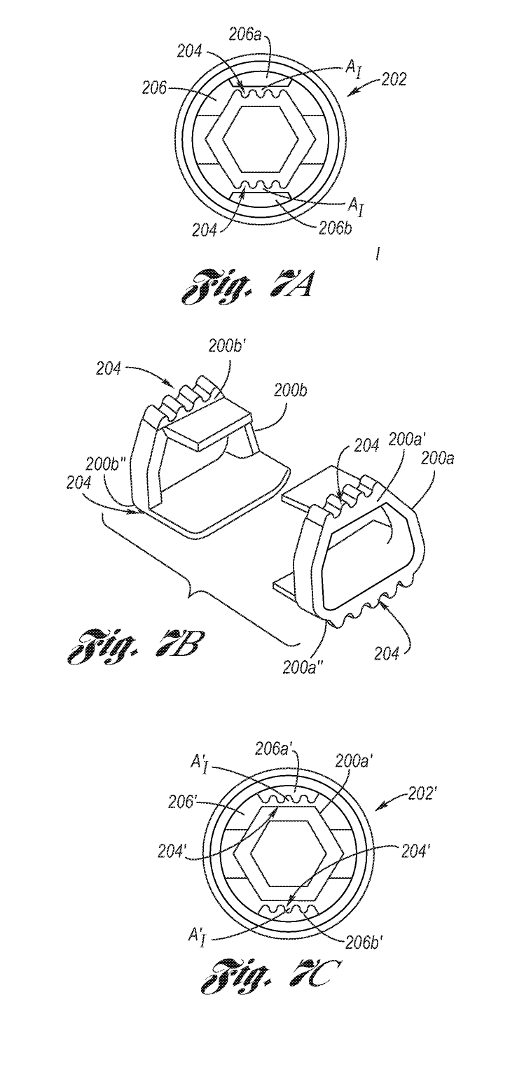

Turning attention now to FIG. 6, depicted is a second aspect of the present invention, wherein now the first and second external snubbers (only external snubber 152 being visible) of an hydraulic ride bushing 150 (which may be otherwise conventional, per FIGS. 2 and 2A, wherein the end cap and sleeve are removed for clarity) are provided with polyurethane P at the abutment portions thereof (only abutment portions 152a′, 152a″ being visible), the remainder being another material, as for example 30% glass filled nylon, or another material. The external snubbers may be provided by the two materials being shot in one tool. The abutment portions abut the bosses of the hydraulic damper 154 (only bosses 154a, 154b being visible), wherein provided a smooth load rate increase at the end of bushing travel to thereby provide a smooth end of travel feel due to the additional damping at the end of bushing travel.

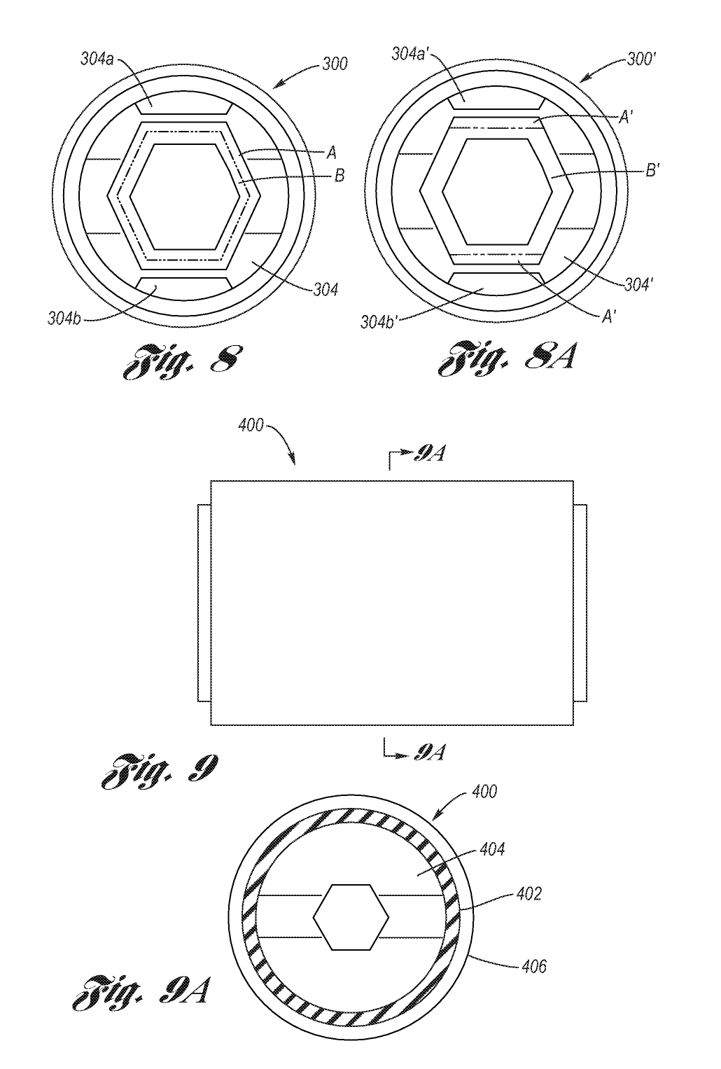

Turning attention next to FIGS. 7A through 7B, depicted is a third aspect of the present invention in which convolutes (i.e., a plurality of nibs, folds or the like) are provided at the abutment interface A_{I}, A_{I}′ between the bosses of the hydraulic damper and the abutment portions of the external snubbers.

In a first version of the third aspect, as shown at FIGS. 7A and 7B, first and second external snubbers 200a, 200b of an hydraulic ride bushing 202 (which may be otherwise conventional, per FIGS. 2 and 2A, wherein the end cap and sleeve are omitted for clarity) are provided at their respective abutment portions 200a′, 200a″, 200b′, 200b″ with a plurality of convolutes 204 which are located so as to face, and abut as the end of bushing travel approaches, the bosses of the hydraulic damper 206 (wherein only bosses 206a, 206b at one end are visible in FIG. 7A). The convolutes 204 provide a soft compressibility of the external snubber 200a, 200b at the abutment interface A_{I}, wherein the external snubbers may be made of polyurethane or another material.

In a second version of the third aspect, as shown at FIG. 7C, the first and second external snubbers (only external snubber 200a′ being visible) of an hydraulic ride bushing 202′ (which may be otherwise conventional, per FIGS. 2 and 2A, wherein the end cap and sleeve are omitted for clarity) have conventionally configured abutment portions, but now the bosses of the hydraulic damper 206′ (only bosses 206a′, 206b′ at one end being visible) are provided with a plurality of convolutes 204′ which are located so as to face, and abut as the end of bushing travel approaches, the abutment portions of the external snubbers. The convolutes 204′ provide a soft compressibility at the abutment interface A_{I}′ for the external snubbers 200a′, 200b′, wherein the external snubbers may be composed of polyurethane or another material.

As such, at each abutment interface A_{I}, A_{I}′, the softer compressibility of the convolutes 204, 204′ provide a soft damping as they compress during compressive abutment of the respective boss and abutment portion, followed by a harder damping provided after the convolutes have largely compressed. This duality of compression afforded by the convolutes 204, 204′ collectively provide a smooth load rate increase at the end of bushing travel to thereby provide a smooth end of travel feel due to the additional damping at the end of bushing travel.

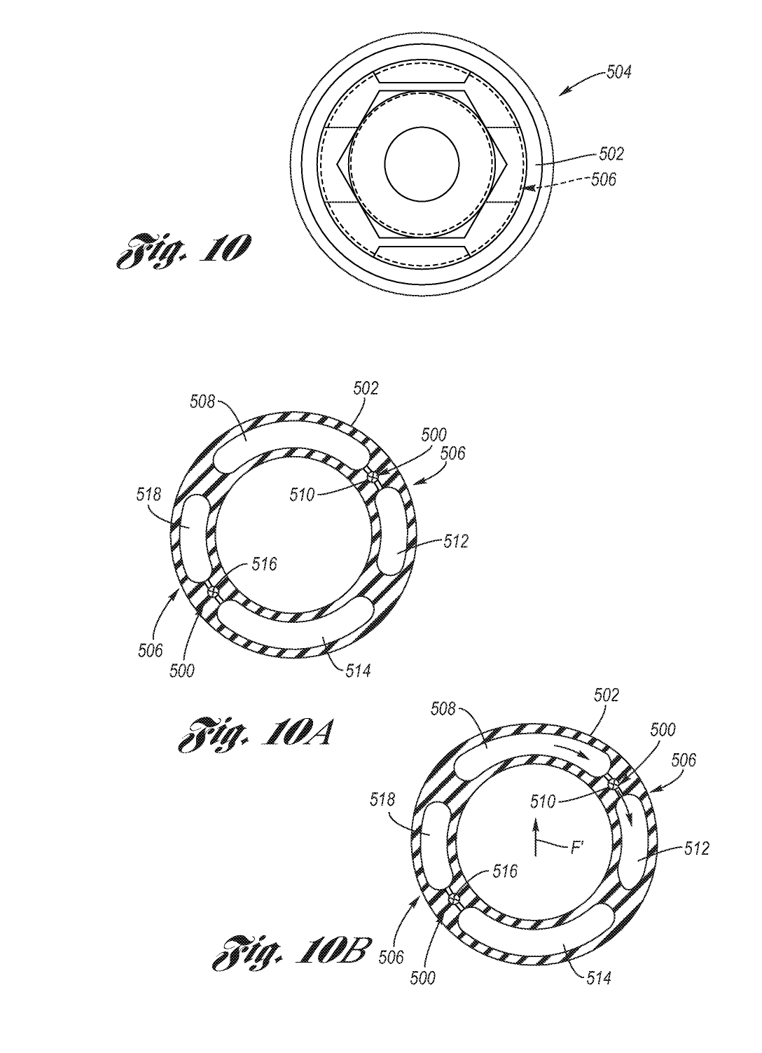

Turning attention next to FIGS. 8 and 8A, depicted is a fourth aspect of the present invention, wherein an hydraulic ride bushing 300, 300′ now includes external snubbers composed of a plurality of materials, wherein the hydraulic ride bushing 300, 300′ may be otherwise conventional as in FIGS. 2 and 2A (wherein the end cap and sleeve are omitted for clarity), except for the multiple material snubbers, which may be provided by the plurality of materials being shot in one tool.

FIG. 8 depicts dual material first and second snubbers (only the first external snubber 300a being visible), wherein, each dual material external snubber is composed of a different durometer material, a first material A having a first durometer and a second material B having a second durometer (i.e., each material has a different elastic modulus). Either one of the first and second materials A, B may be the harder (or softer) of the other. Since the softer material, one of material A and material B, provides a soft compressibility of each of the external snubbers upon abutment with respective bosses 304a or 304b of the hydraulic damper 304, and since this is then followed by the compressibility of the harder material, the other of material A and material B, this collective duality of compressibility provides a smooth load rate increase at the end of travel of the hydraulic damper to thereby provide a smooth end of travel feel due to the additional damping at the end of bushing travel.

FIG. 8A depicts dual material first and second snubbers (only the first external snubber 300a′ being visible), wherein, each dual material external snubber has the abutment portion thereof (only abutment portions 300a′, 300a″ being visible) composed of a different durometer material, a first material A′ having a first durometer and a second material B′ having a second durometer (i.e., each material has a different elastic modulus). Since the softer material, one of material A′ and material B′, provides a soft compressibility of each of the external snubbers upon abutment with respective bosses 304a′ or 304b′ of the hydraulic damper 304′, and since this is then followed by the compressibility of the harder material, the other of material A′ and material B′, this collective duality of compressibility provides a smooth load rate increase at the end of travel of the hydraulic damper to thereby provide a smooth end of travel feel due to the additional damping at the end of bushing travel. While either one of the first and second materials A′, B′ may be the harder (or softer) of the other, a preferred embodiment of FIG. 8A has material A′ being polyurethane.

By way merely of exemplification, material A, A′ may be polyurethane and material B, B′ may be 30% glass filled nylon. Generally speaking, the relative thickness and the choice of compositions as between the two materials A, A′ and B, B′ may be adjusted so to provide a desired smooth damping at the end of bushing travel. Additionally, more than two different materials may be utilized.

Turning attention now to FIGS. 9 and 9A, depicted is a fifth aspect of the present invention, wherein an hydraulic ride bushing 400 now has an internally disposed snubber 402 located between the hydraulic damper 404 and the outer cylindrical shell 406 thereof. The elastic modulus of the internal snubber 402 may be utilized to provide damping at the end of bushing travel with or without external snubbers, preferably with external snubbers, wherein the hydraulic ride bushing may be otherwise conventional as in FIGS. 2 and 2A except for the presence of the internal snubber (the end cap, external snubber, and sleeve being removed from the view at FIG. 9A for clarity), and wherein the external snubbers may be composed of polyurethane. If without external snubbers, the internal snubber 402 has a composition, which may be polyurethane, selected to provide a smooth load rate increase at the end of bushing travel and thereby provide a smooth end of travel feel due to the additional damping at the end of bushing travel; and, if external snubbers are present, the compositions thereof, which may be polyurethane, are selected in combination to provide a smooth load rate increase at the end of bushing travel and thereby provide a smooth end of travel feel due to the additional damping at the end of bushing travel.

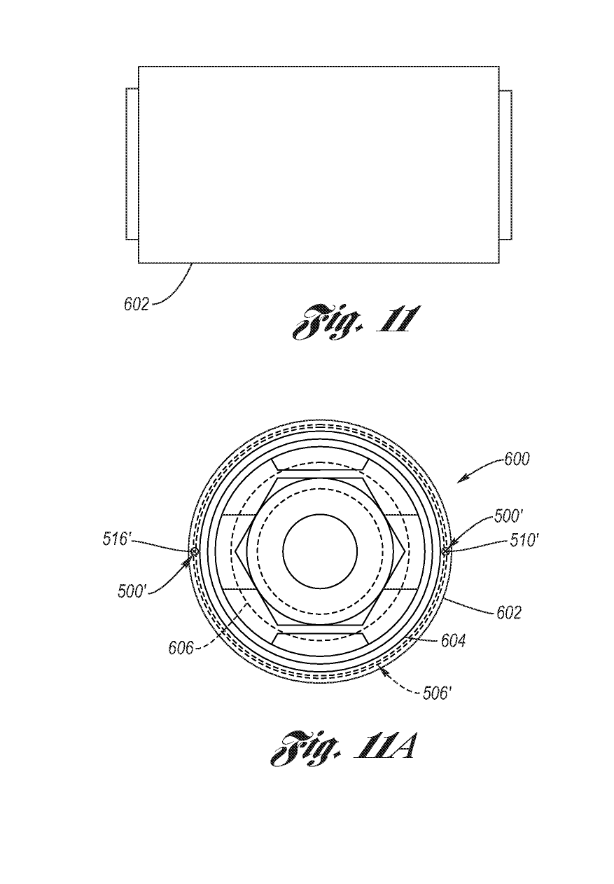

Attention next is directed to FIGS. 10 through 10B, where depicted is a sixth aspect of the present invention, in which an hydraulic lock 500 is provided within the hydraulic damper 502 of an hydraulic ride bushing 504, being interfaced with the internal hydraulic damping mechanism 506. The hydraulic ride bushing 504 may be otherwise conventional as for example shown at FIGS. 2 and 2A, with the exception of the hydraulic damper 502, and wherein the external snubbers may be composed of polyurethane.

In contradistinction to the conventional hydraulic damper 22 shown at FIG. 2B, FIGS. 10A and 10B show a schematic representation of the hydraulic damper 502 having internal hydraulic lock 500 according to the present invention. The internal hydraulic damping mechanism 506 is schematically represented by a first hydraulic fluid reservoir 508 connected through a first check valve 510 to a first expansion bladder 512, and an oppositely disposed second hydraulic fluid reservoir 514 connected through a second check valve 516 to a second expansion bladder 518. The first and second check valves are each of a conventional check valve structure, wherein hydraulic fluid flow therethrough is permitted because the check valve is in an open state; and upon a preset pressure of the hydraulic fluid being attained, the check valve switches internally to a closed state, whereupon hydraulic fluid flow therethrough is prevented until the pressure drops below the preset value and the check vale returns to its open state.

In operation as shown at FIG. 10B, when the hydraulic damper 502 is subjected to an applied load force F′, hydraulic fluid flows from the respectively compressed hydraulic fluid reservoir 508 to its connected expansion bladder 512, wherein when pressure of the hydraulic fluid reaches a preset level, the respective check valve 510 closes, whereupon hydraulic fluid in the compressed hydraulic reservoir cannot escape therefrom, whereupon a smooth load rate increase at the end of bushing travel and thereby provide a smooth end of travel feel due to the additional damping at the end of bushing travel.

Turning now to FIGS. 11 and 11A, depicted is a seventh aspect of the present invention, in which an hydraulic ride bushing 600 now includes an external hydraulic damper 602, wherein the hydraulic ride bushing may, for example, be conventional as per FIGS. 2 and 2A, except for the external hydraulic damper, and wherein the external snubbers may be composed of polyurethane.

The external hydraulic damper 602 is disposed circumferentially external to the outer cylindrical shell 604 of the hydraulic ride bushing 600. Preferably, the external hydraulic damper is structurally similar to either that of the above described internally disposed hydraulic damper 22, wherein no hydraulic lock is provided, or that of the above described hydraulic damper 502 (shown schematically in FIG. 10A), wherein the hydraulic damping mechanism 506′ includes an hydraulic lock 500′.

In operation, both the external and internal hydraulic dampers 602, 606 compress when a load is applied to the hydraulic ride bushing. Hydraulic fluid within the hydraulic damping mechanism 506′ redistributes, as for example shown schematically at FIG. 10B, and the pressure thereof rises. Upon the hydraulic pressure reaching the predetermined shut-off level, the appropriate check valve 510′ or 516′ closes, with a result similar to that described with respect to FIG. 10B, wherein the external and internal hydraulic dampers are predetermined so as to provide a smooth load rate increase at the end of bushing travel and thereby provide a smooth end of travel feel due to the additional damping at the end of bushing travel.

To those skilled in the art to which this invention appertains, the above described preferred embodiment may be subject to change or modification. Such change or modification can be carried out without departing from the scope of the invention, which is intended to be limited only by the scope of the appended claims.

1. An hydraulic ride bushing, comprising:
an outer cylindrical shell;
an hydraulic damper disposed within said outer cylindrical shell, said hydraulic damper having mutually opposed ends, each end having formed thereat a recess, each recess having a pair of radially opposed bosses; and
a pair of external snubbers, one external snubber disposed, respectively, at each recess of said hydraulic damper, each external snubber having a pair of radially opposed abutment portions which respectively face the bosses of its respective recess;
wherein the abutment portions of each said external snubber of said pair of external snubbers are composed of polyurethane.

2. The hydraulic ride bushing of claim 1, wherein each said external snubber is composed of polyurethane.

3. The hydraulic ride bushing of claim 2, wherein each said external snubber is composed of FPU 1376-31 polyurethane.

4. An hydraulic ride bushing, comprising:
an outer cylindrical shell;
an hydraulic damper disposed within said outer cylindrical shell, said hydraulic damper having mutually opposed ends, each end having formed thereat a recess, each recess having a pair of radially opposed bosses; and
a pair of external snubbers, one external snubber disposed, respectively, at each recess of said hydraulic damper, each external snubber having a pair of radially opposed abutment portions which respectively face the bosses of its respective recess;
wherein an abutment interface is formed between each abutment portion and a respective boss; and
wherein a plurality of convolutes is formed on a selected one of the boss and the abutment portion at each said abutment interface.

5. The hydraulic ride bushing of claim 4, wherein each said external snubber is composed of polyurethane.

6. The hydraulic ride bushing of claim 4, wherein said plurality of convolutes is formed on each said boss.

7. The hydraulic ride bushing of claim 4, wherein said plurality of convolutes is formed on each said abutment portion.

8. The hydraulic ride bushing of claim 5, wherein each said external snubber is composed of polyurethane.

9. An hydraulic ride bushing, comprising:
an outer cylindrical shell;
an hydraulic damper disposed within said outer cylindrical shell, said hydraulic damper having mutually opposed ends, each end having formed thereat a recess, each recess having a pair of radially opposed bosses; and
a pair of external snubbers, one external snubber disposed, respectively, at each recess of said hydraulic damper, each external snubber having a pair of radially opposed abutment portions which respectively face the bosses of its respective recess;
wherein each said external snubber comprises at least in part a composition comprising a plurality of differing elastic modulus materials.

10. The hydraulic ride bushing of claim 9, wherein said composition comprises a first material having a first elastic modulus, and a second material having a second elastic modulus, wherein said first material is softer than said second material, and wherein said first and second materials are concentrically disposed with respect to each other.

11. The hydraulic ride bushing of claim 10, wherein one of said first and second materials is composed of polyurethane.

12. The hydraulic ride bushing of claim 10, wherein said composition is disposed at said abutment portions in facing relation to the respective bosses, and wherein said first material is polyurethane.

13. An hydraulic ride bushing, comprising:
an outer cylindrical shell;
an hydraulic damper concentrically disposed within said outer cylindrical shell; and
an internal snubber disposed concentrically between said outer cylindrical shell and said hydraulic damper.

14. The hydraulic ride bushing of claim 13, wherein said internal snubber is composed of polyurethane.

15. The hydraulic ride bushing of claim 13, wherein said hydraulic damper has mutually opposed ends, each end having formed thereat a recess, each recess having a pair of radially opposed bosses; said hydraulic ride bushing further comprising:
a pair of external snubbers, one external snubber disposed, respectively, at each recess of said hydraulic damper, each external snubber having a pair of radially opposed abutment portions which respectively face the bosses of its respective recess;
wherein internal snubber and said pair of external snubbers are each composed of polyurethane.

16. An hydraulic ride bushing, comprising:
an outer cylindrical shell;
an hydraulic damper disposed within said outer cylindrical shell, said hydraulic damper having an internal hydraulic damping mechanism in which hydraulic fluid flows in response to compressive loads applied to said hydraulic damper; and
an hydraulic lock mechanism operably interfaced with said internal hydraulic damping mechanism, wherein above a predetermined hydraulic fluid pressure, flow of hydraulic fluid within said internal hydraulic damping mechanism is prevented.

17. The hydraulic ride bushing of claim 16, wherein said hydraulic damper has mutually opposed ends, each end having formed thereat a recess, each recess having a pair of radially opposed bosses further comprising:
a pair of external snubbers, one external snubber disposed, respectively, at each recess of said hydraulic damper, each external snubber having a pair of radially opposed abutment portions which respectively face the bosses of its respective recess;
wherein each said external snubber is composed of polyurethane.

18. An hydraulic ride bushing, comprising:
an outer cylindrical shell;
an internal hydraulic damper disposed within said outer cylindrical shell; and
an external hydraulic damper disposed concentrically outside said outer cylindrical shell.

19. The hydraulic ride bushing of claim 18, wherein said internal hydraulic damper has mutually opposed ends, each end having formed thereat a recess, each recess having a pair of radially opposed bosses; said hydraulic ride bushing further comprising:
a pair of external snubbers, one external snubber disposed, respectively, at each recess of said hydraulic damper, each external snubber having a pair of radially opposed abutment portions which respectively face the bosses of its respective recess;
wherein each said external snubber is composed of polyurethane.

20. The hydraulic ride bushing of claim 18, wherein said external hydraulic damper has an external damper hydraulic damping mechanism in which hydraulic fluid flows in response to loads applied to said external hydraulic damper; and
a first hydraulic lock mechanism operably interfaced with said external damper hydraulic damping mechanism, wherein above a first predetermined hydraulic fluid pressure, flow of hydraulic fluid within said external damper hydraulic damping mechanism is prevented.

21. The hydraulic ride bushing of claim 20, wherein said internal hydraulic damper has mutually opposed ends, each end having formed thereat a recess, each recess having a pair of radially opposed bosses; said hydraulic ride bushing further comprising:
a pair of external snubbers, one external snubber disposed, respectively, at each recess of said hydraulic damper, each external snubber having a pair of radially opposed abutment portions which respectively face the bosses of its respective recess;
wherein each said external snubber is composed of polyurethane.

22. The hydraulic ride bushing of claim 20, wherein said internal hydraulic damper has an internal damper hydraulic damping mechanism in which hydraulic fluid flows in response to loads applied to said internal hydraulic damper; and
a second hydraulic lock mechanism operably interfaced with said internal damper hydraulic damping mechanism, wherein above a second predetermined hydraulic fluid pressure, flow of hydraulic fluid within said internal damper hydraulic damping mechanism is prevented.

23. The hydraulic ride bushing of claim 22, wherein said internal hydraulic damper has mutually opposed ends, each end having formed thereat a recess, each recess having a pair of radially opposed bosses; said hydraulic ride bushing further comprising:
a pair of external snubbers, one external snubber disposed, respectively, at each recess of said hydraulic damper, each external snubber having a pair of radially opposed abutment portions which respectively face the bosses of its respective recess;
wherein each said external snubber is composed of polyurethane.

24. In an hydraulic ride bushing comprising an outer shell, an hydraulic damper, and a pair of external snubbers configured to selectively abut the hydraulic damper responsive to loads applied to said hydraulic damper with respect to said outer shell, an improvement thereto comprising:
said pair of external snubbers, each external snubber being composed of polyurethane.
